(19) United States
(12) Patent Application Publication
(10) Pub. No.: US 2012/0189087 A1
(43) Pub. Date: Jul. 26, 2012

(54) OSCILLATION POWER RANGE MONITOR AND METHOD OF CHECKING SOUNDNESS THEREOF

(75) Inventors: Masahiro Hashiba, Tokyo (JP); Tadashi Miyazaki, Kanagawa (JP); Norihiro Umemura, Tokyo (JP); Yuta Sakai, Tokyo (JP)

(73) Assignee: KABUSHIKI KAISHA TOSHIBA

(21) Appl. No.: 13/354,987

(22) Filed: Jan. 20, 2012

(30) Foreign Application Priority Data
Jan. 21, 2011 (JP) 2011-010999

(51) Int. Cl. G21C 7/36

(52) U.S. Cl. 376/217

(57) ABSTRACT

An oscillation power range monitor has: an input signal processing section that calculates a normalized cell value from LPRM signals input from local power range monitors; a soundness checking basic signal generating section that generates a simulated cell value that is variable on a time series basis; and a trip determining section that receives the normalized cell value and the simulated cell value respectively from the input signal processing section and the soundness checking basic signal generating section as input, compares the normalized cell value and the simulated cell value with a determination threshold value and outputs a scram trip signal when either of them exceeds the determination threshold value.

### CROSS-REFERENCE TO RELATED APPLICATIONS

This application is based upon and claims the benefit of priority from Japanese Paten Application No. 2011-010999 filed on Jan. 21, 2011, the entire content of which is incorporated herein by reference.

### FIELD

Embodiments described herein relate to an oscillation power range monitor to be used as reactor core stability measures of a boiling water reactor and a method of checking the soundness thereof.

### BACKGROUND

Oscillation power range monitors (to be referred to as OPRMs hereinafter) are being employed for boiling water reactors as reactor core stability measures. Such an OPRM is disclosed in Jpn. Pat. Appln. Laid-Open Publication No. 04-335197, the entire content of which is incorporated herein by reference. An OPRM system incorporating such an OPRM is designed to suppress neutron flux oscillations before the fuel soundness is damaged. The OPRM system detects neutron flux oscillations that are oscillations specifically characteristic relative to nuclear thermal hydraulic stability and causing a nuclear reactor scram to take place.

An OPRM has an input signal processing section to which the signals from local power range monitors (to be referred to as LPRMs hereinafter) are input and a trip determining section that senses the amplitude and the period of the signal from the input signal processing section and outputs a scram trip signal when either of them exceeds a determination threshold value or both of them exceed respective determination threshold values.

Conventional OPRMs are so designed as to receive fixed simulated LPRM signals at the input signal processing section in parallel with LPRM detection signals and constantly execute a self-diagnosis operation for the input signal processing section.

However, the trip determining section that catches a change in the cell value on a time series basis for trip determination cannot check the soundness of trip determination function by means of a given fixed determination threshold value.

### BRIEF DESCRIPTION OF THE DRAWINGS

The features and advantages of the present invention will become apparent from the discussion hereinbelow of specific, illustrative embodiments thereof presented in conjunction with the accompanying drawings, wherein:

FIG. 1 is a block diagram of an OPRM according to a first embodiment, illustrating the configuration thereof;

FIG. 2 is a graph schematically illustrating an ABA trip;

FIG. 3 is a flowchart of an ABA trip determining algorithm;

FIG. 4 is a graph schematically illustrating a GRA trip;

FIG. 5 is a flowchart of a GRA trip determining algorithm;

FIG. 6 is a graph schematically illustrating a PBDA trip;

FIG. 7 is a flowchart of a PBDA trip determining algorithm;

FIG. 8 is a graph schematically illustrating an abnormal spot identifying signal of the ABA/GRA trip determining sections according to a second embodiment;

FIG. 9 is a graph schematically illustrating an abnormal spot identifying signal of the PBDA trip determining section according to the second embodiment;

FIG. 10 is a graph illustrating the simulated cell value of the ABA trip determining section that corresponds to a change in the determination threshold value according to a third embodiment; and

FIG. 11 is a block diagram of the OPRM according to a fourth embodiment, illustrating the configuration thereof.

### DETAILED DESCRIPTION

In view of the above-identified problem, an object of the present embodiments is to provide an oscillation power range monitor that can check the soundness of the trip determining section and a method of checking the soundness thereof.

According to an embodiment, an oscillation power range monitor comprises: an input signal processing section that calculates a normalized cell value from LPRM signals input from local power range monitors; a soundness checking basic signal generating section that generates a simulated cell value that is variable on a time series basis; and a trip determining section that receives the normalized cell value and the simulated cell value respectively from the input signal processing section and the soundness checking basic signal generating section as input, compares the normalized cell value and the simulated cell value with a determination threshold value and outputs a scram trip signal when either of them exceeds the determination threshold value.

According to another embodiment, an oscillation power range monitor comprises: a soundness checking basic signal generating section that generates a signal for generating a simulated cell value that is variable on a time series basis; an input signal processing section that calculates a normalized cell value and the simulated cell value respectively from LPRM signals input from local power range monitors and from a signal input from the soundness checking basic signal generating section; and a trip determining section that receives the normalized cell value and the simulated cell value from the input signal processing section as input, compares the normalized cell value and the simulated cell value with a determination threshold value and outputs a scram trip signal when either of them exceeds the determination threshold value, and the soundness checking basic signal generating section generating a fixed simulated LPRM signal and outputting the fixed simulated LPRM signal to the input signal processing section.

According to yet another embodiment, a method of checking the soundness of an oscillation power range monitor, the method comprises: a step of calculating a normalized cell value from LPRM signals input from local power range monitors; a step of generating a simulated cell value that is variable on a time series basis; a step of comparing the normalized cell value and the simulated cell value with a determination threshold value; and a step of outputting a scram trip signal when either of the normalized cell value and the simulated cell value exceeds the determination threshold value.

Now, preferred embodiments of oscillation power range monitors and those of method of checking the soundness thereof according to the present invention will be described below by referring to the accompanying drawings. Throughout the drawings, same or similar sections are denoted by the same reference symbols and will not be described repeatedly.

### First Embodiment

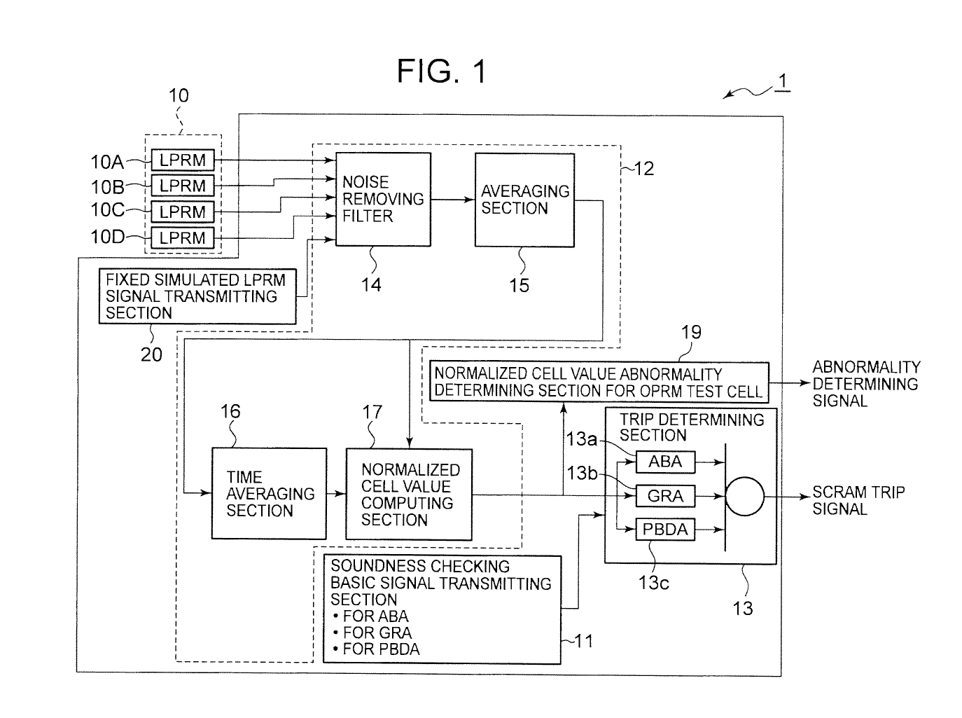

FIG. 1 is a block diagram of an OPRM according to the first embodiment, illustrating the configuration thereof.

The OPRM 1 includes a fixed simulated LPRM signal transmitting section 20, an input signal processing section 12, a normalized cell value abnormality determining section 19, a soundness checking basic signal transmitting section 11 and a trip determining section 13. The input signal processing section 12 by turn includes a noise removing filter 14, an averaging section 15, a time averaging section 16 and a normalized cell value computing section 17.

The fixed simulated LPRM signal transmitting section 20 transmits fixed simulated LPRM signals for soundness checking that are input to a test OPRM cell in order to make the normalized cell value of the test OPRM cell reaches a target value. The input signal processing section 12 receives as input the LPRM detection signals of the LPRMs 10 arranged in the nuclear reactor and the fixed simulated LPRM signals.

The OPRM 1 receives LPRM detection signals of 52 channels from LPRMs 10A to 10D. The LPRM detection signals and the fixed simulated LPRM signals that are received are then sent to the noise removing filter 14.

The received signals are filtered by the noise removing filter 14 to remove the noises thereof. After the noise removal, the LPRM readings are assigned to 44 OPRM cells formed by LPRM detector assemblies for 4 channels and then sent to the averaging section 15. After the noise removal, the fixed simulated LPRM value is assigned to the test OPRM cell and then sent to the averaging section 15.

The averaging section 15 calculates the average value of the LPRM readings assigned to each of the OPRM cells and also calculates the average value of the fixed simulated LPRM value assigned to the test OPRM cell.

Then, the time averaging section 16 calculates the time average value of the 45 average values including the average value for the test OPRM cell. Then, the time average value is sent to the normalized cell value computing section 17.

The normalized cell value computing section 17 calculates the average value in the height direction and also the time average value and determines the normalized cell value of each of the OPRM cells and that of the test OPRM cell. The normalized cell values of the OPRM cells are input to the trip determining section 13, while the normalized cell value of the test OPRM cell is input to the normalized cell value abnormality determining section 19 of the test OPRM cell.

The normalized cell value abnormality determining section 19 of the test OPRM cell operates for abnormality determination of the input signal processing section 12 by determining whether the normalized cell value of the test OPRM cell obtained as a result of the arithmetic operation reaches the target value or not.

The soundness checking basic signal transmitting section 11 generates a simulated cell value that is variable on a time series basis and outputs it to the trip determining section 13 at arbitrary timings (e.g., at timings of when switching to a trip point calibration mode or at regular periods).

The trip determining section 13 includes an amplitude base trip (ABA trip) determining section 13a, a growth rate trip (GRA trip) determining section 13b and a period base trip (PBDA trip) determining section 13c. Thus, it monitors the output oscillations by means of the diversified algorithms of three different kinds and outputs a scram trip signal when the determination threshold value of one of these sections is exceeded.

The amplitude base trip (ABA trip) determining section 13a outputs a scram trip signal when the peak of amplitude exceeds its determination threshold value within a predetermined time period. The growth rate trip (GRA trip) determining section 13b senses abrupt oscillations of a cell signal and outputs a scram trip signal when they exceed the determination threshold value. The period base trip (PBDA trip) determining section 13c senses oscillations with a specific period and outputs a scram trip signal when they exceed the determination threshold value.

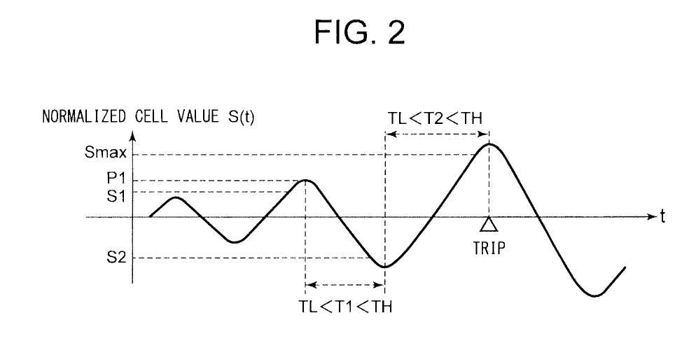

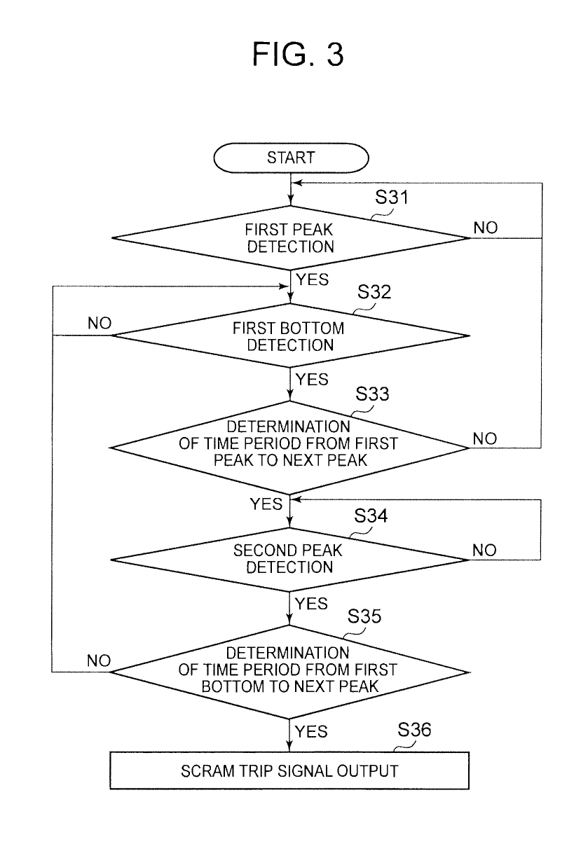

The determination steps in the operation of the ABA trip determining section 13a and how the normalized cell value and the determination threshold value are compared will be described below by referring to FIG. 2, which is a graph schematically illustrating an ABA trip determining operation, and to FIG. 3, which is a flowchart of the ABA trip determining algorithm.

First Peak Detection (S31):

The ABA trip determining section 13a compares the peak value of the normalized cell value S(t) with the determination threshold value S1 and detects the first peak P1 that exceeds the determination threshold value S1. Note that S(t) is a function of time (t).

First Bottom Detection (S32):

When the first peak P1 is detected in the step S31, the ABA trip determining section 13a compares the bottom value of the normalized cell value S(t) and the determination threshold value S2 and detects the first bottom that falls below the determination threshold value S2.

Determination of elapsed time from first peak to next peak (S33):

When the first bottom is detected in the step S32, the ABA trip determining section 13a determines whether the time between the first peak P1 and the first bottom is within a predetermined time period T1 or not. When the time exceeds the predetermined time T1, the ABA trip determining section 13a returns to the step S31.

Second Peak Detection (S34):

When the time between the first peak P1 and the first bottom is within the predetermined time period T1 in the step S33, the ABA trip determining section 13a compares the peak value of the normalized cell value S(t) with the determination threshold value Smax and detects the second peak that exceeds the determination threshold value Smax.

Determination of Elapsed Time from First Bottom to Next Peak (S35):

When the second peak is detected in the step S34, the ABA trip determining section 13a determines if the time between the first bottom and the second peak is within a predetermined time period T2 or not. When the time exceeds the predetermined time period T2, the ABA trip determining section 13a returns to the step S32.

Scram Trip Signal Output (S36):

When the time period between the first bottom and the second peak is within predetermined time period T2 in the step S35, the ABA trip determining section 13a outputs a scram trip signal.

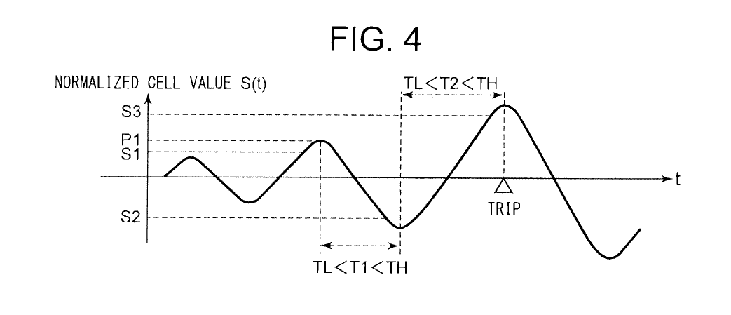

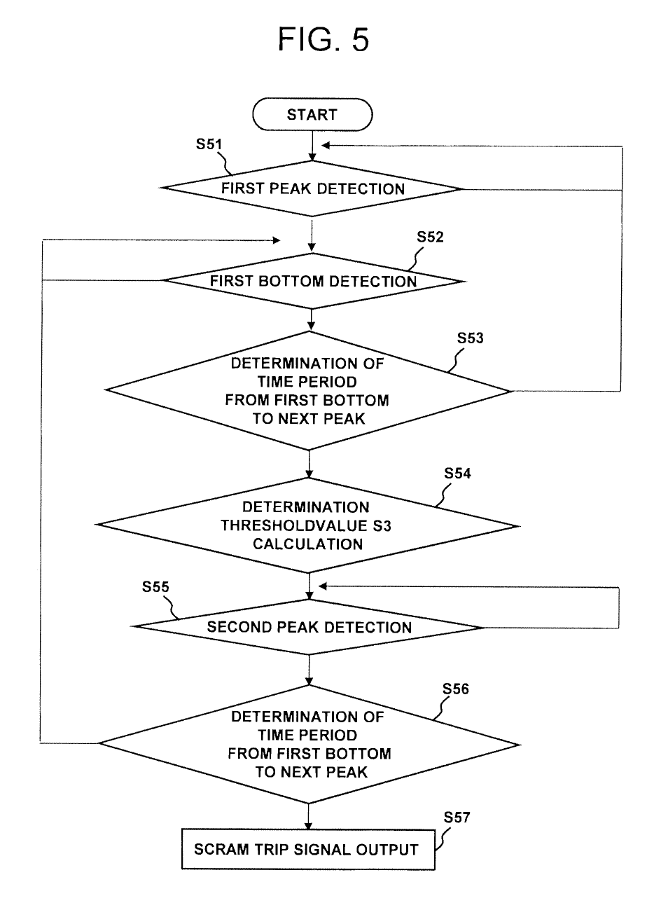

Now, the determination steps in the operation of the GRA trip determining section 13b and how the normalized cell value and the determination threshold value are compared will be described below by referring to FIGS. 4 and 5. FIG. 4 is a graph schematically illustrating a GRA trip determining operation, and FIG. 5 is a flowchart of the GRA trip determining algorithm.

The GRA trip determining section 13b determines a trip on the basis of the rate at which oscillations of an OPRM cell signal grows. The algorithm of the GRA trip determining section 13b is similar to that of the ABA trip determining section 13a but differs from the latter in terms of detection of the second peak (S55).

Determination Threshold Value S3 Calculation (S54):

When the time period between the first peak P1 and the first bottom is within predetermined time period T1 in the step S53, the GRA trip determining section 13b calculates determination threshold value S3 from the first peak value P1 of the immediately preceding cycle and the permissible largest growth rate DR3. The GRA trip determining section 13b calculates the determination threshold value S3 based on the first peak value p1 and permissible maximum growth rate DR3.

Second Peak Detection (S55):

Then, the GRA trip determining section 13b compares the determination threshold value S3 with the peak value of the normalized cell value S(t) to detect the second peak that exceeds the determination threshold value S3.

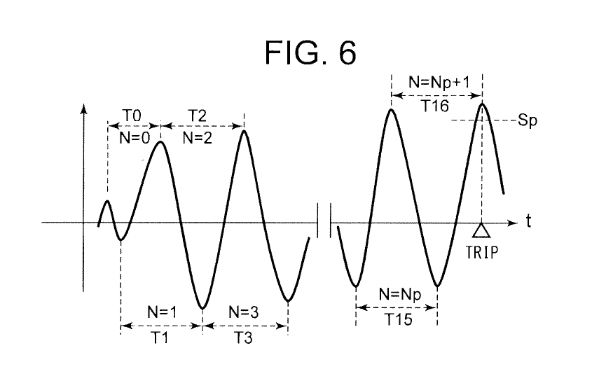

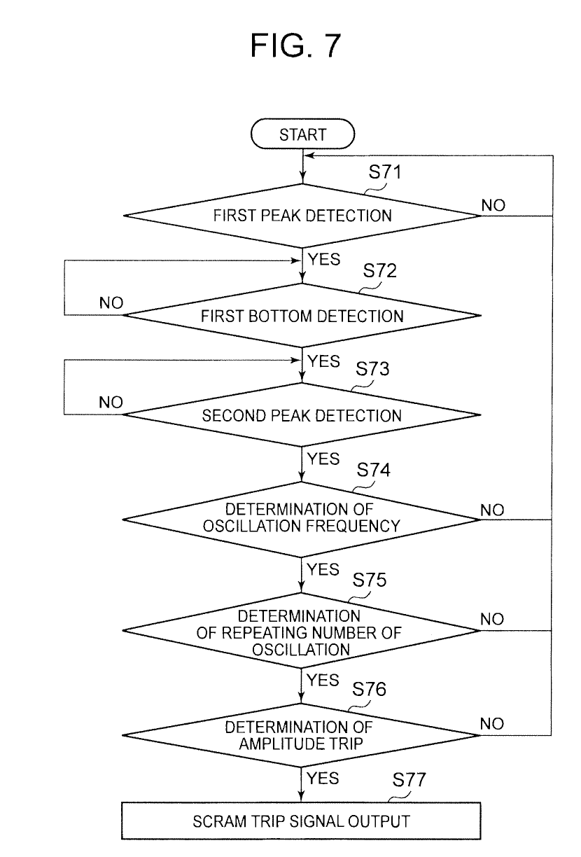

Now, the determination steps in the operation of the PBDA trip determining section 13c and how the normalized cell value and the determination threshold value are compared will be described below by referring to FIGS. 6 and 7. FIG. 6 is a graph schematically illustrating a PBDA trip determining operation, and FIG. 7 is a flowchart of the PBDA trip determining algorithm.

The PBDA trip determining section 13c senses the repeating number of oscillations N of a specific frequency and the normalized cell value S(t) thereof. Its operation of catching a change in the cell value on a time series basis is the same as that of the ABA trip determining section and that of the GRA trip determining section.

First Peak Detection (S71):

The PBDA trip determining section 13c detects the first peak of the normalized cell value S(t).

First Bottom Detection (S72):

When the PBDA trip determining section 13c detects the first peak in the step S71, it then detects the first bottom of the normalized cell value S(t).

Second Peak Detection (S73):

When the PBDA trip determining section 13c detects the first bottom in the step S72, it then detects the second peak of the normalized cell value S(t).

Determination of Oscillation Frequency (S74):

When the PBDA trip determining section 13c detects the second peak in the step S73, it then determines the oscillation frequency from the first peak, the first bottom and the second peak.

Determination of Repeating Number of Oscillations (S75):

When the PBDA trip determining section 13c determines the oscillation frequency in the step S74, it compares the repeating number of oscillations N in specific time periods (T0 to T16) with determination threshold value Np and determines whether the repeating number of oscillations N exceeds the determination threshold value Np or not.

Determination of Amplitude Trip (S76):

When the repeating number of oscillations N exceeds the determination threshold value Np in the step S75, the PBDA trip determining section 13c compares the amplitude of the normalized cell value S(t) and the amplitude trip determination threshold value Sp and determines whether the amplitude of the normalized cell value S(t) exceeds the amplitude trip determination threshold value Sp or not.

Scram Trip Signal Output (S77):

When the amplitude of the normalized cell value S(t) exceeds the amplitude trip determination threshold value Sp in the step S76, the PBDA trip determining section 13c outputs a scram trip signal.

A simulated cell value is input from the soundness checking basic signal transmitting section 11 to the trip determining section 13. When the output of the trip determining section 13 differs from the output of the simulated cell value in normal operation, for example when so scram trip signal is output although a simulated cell value exceeding the determination threshold value is input or when so scram trip signal is output although a simulated cell value not exceeding the determination threshold value is input, a message telling that there is something wrong with the trip determining section 13 is displayed typically on the front panel of the OPRM.

The soundness checking basic signal transmitting section 11, the input signal processing section 12 and the trip determining section 13 are formed by using an FPGA (Field Programmable Gate Array) that can operate at an improved processing speed and has a large scale capacity.

Thus, by this embodiment, the verification performance of an OPRM can be improved by inputting a simulated cell value that is variable on a time series basis to the trip determining section 13 to check the soundness of the ABA trip determining section, the GRA trip determining section and the PBDA trip determining section. Additionally, the overall processing operation can be executed at high speed when the soundness checking basic signal transmitting section 11, the input signal processing section 12 and the trip determining section 13 are formed by using an FPGA.

### Second Embodiment

Now, the second embodiment of the present invention will be described below by referring to the related drawings.

The OPRM configuration is the same as the one illustrated in FIG. 1, although the soundness checking basic signal transmitting section 11 is adapted to output an abnormal spot identifying signal. The abnormal spot identifying signal is input to the trip determining section 13. Then, it is possible to identify the abnormal spot by extracting the determinations of the trip determining section 13 relative to the abnormal spot identifying signal and comparing them with the output in normal operation relative to the abnormal spot identifying signal.

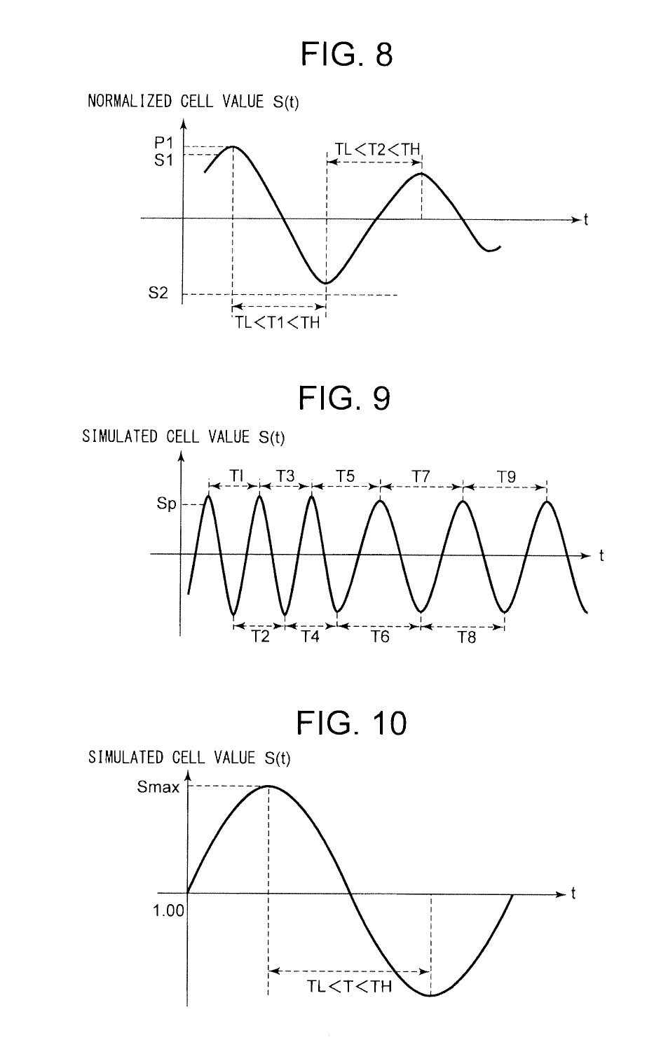

FIG. 8 is a graph schematically illustrating an exemplar abnormal spot identifying signal of the ABA/GRA trip determining sections 13a, 13b of the second embodiment. This abnormal spot identifying signal satisfies the requirement of detection of the first peak (S31/S51) but does not satisfy the requirement of detection of the first bottom (S32/S52) and that of detection of the second bottom (S34/S54). Then, it is possible to identify the abnormal spot by extracting the determinations for detection of the first peak (S31/S51), for detection of the first bottom (S32/S52) and for detection of the second peak (S34/S54) and comparing them with the output in normal operation relative to the abnormal spot identifying signal.

FIG. 9 is a graph schematically illustrating an exemplar abnormal spot identifying signal of the PBDA trip determining section 13c. This abnormal spot identifying signal is formed by using frequencies T5 to T9 that are not specific frequencies and frequencies Tito T4 that are specific frequencies of the PBDA trip determining algorithm. This abnormal spot identifying signal satisfies the requirement of detection of the first peak (S71), that of detection of the first bottom (S72) and that of detection of the second bottom (S73) (Steps S71 to S73 are to be referred to as PBDA trip determination peak/bottom detections hereinafter) but does not satisfy the requirement of determination of the oscillation frequency (S74). Then, it is possible to identify the abnormal spot by extracting the PBDA trip determination peak/bottom detections relative to the abnormal spot identifying signal and the determination of the oscillation frequency (S74) and comparing them with the output in normal operation relative to the abnormal spot identifying signal.

Thus, by this embodiment, it is additionally possible to identify an abnormal spot by generating an abnormal spot identifying signal for identifying an abnormal spot in the trip determining section 13 by the soundness checking basic signal transmitting section 11 and hence by having an abnormal spot identifying signal corresponding to one of the requirement determining sections with a simulated cell value.

### Third Embodiment

Now, the third embodiment of the present invention will be described below by referring to the related drawings.

The OPRM configuration is the same as the one illustrated in FIG. 1, although the soundness checking basic signal transmitting section 11 is adapted to generate a simulated cell value that is interlocked with a change in the trip determination requirements of the OPRM. The OPRM determines a trip on the basis of the amplitude and the oscillation intervals of the waveform of the normalized cell value. In other words, the OPRM determines the trip on the basis of the defined amplitude for determination, the smallest oscillation interval for determination and the largest oscillation interval for determination. When any of the trip determination requirements of the OPRM is changed and the defined amplitude for determination, the smallest oscillation interval for determination or the largest oscillation interval for determination is altered by the operator, the soundness checking basic signal transmitting section 11 generates a simulated cell value that is interlocked with the change in the defined values as a result of the change in the trip determination requirements to check the soundness of the trip determining section 13.

FIG. 10 is a graph illustrating the simulated cell value of the ABA trip determining section 13a that corresponds to a change in the determination threshold value. The simulated cell value of the ABA trip determining section 13a is defined by means of the sinusoidal wave for soundness checking expressed by formula (I) shown below:

S(t)=(Smax−1.00)*sin(taba)+1.00 (1)

### Where:

Smax is the defined amplitude value for ABA trip determination;

T is the period;

TL (the smallest oscillation interval for determination)<T<TH (the largest oscillation interval for determination); and

taba: (π/T)*t.

Thus, by this embodiment, a simulated cell value that is interlocked with a change in the determination threshold value is generated by using a soundness checking sinusoidal wave so that it is possible to check the soundness of the trip determining section when any of the trip determination requirements is changed.

A value in the range of the largest oscillation interval for determination is employed on the basis of the smallest oscillation interval for determination when defining the phase of the soundness checking sinusoidal wave.

### Fourth Embodiment

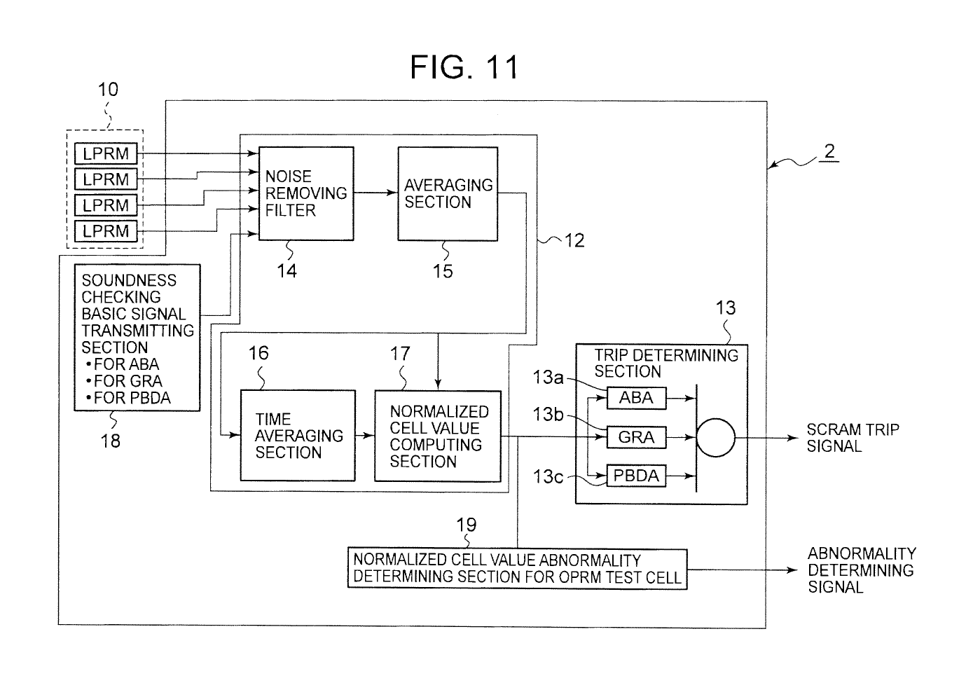

FIG. 11 is a block diagram of the fourth embodiment of OPRM, illustrating the configuration thereof. In FIG. 11, the components that are the same as or similar to those of FIG. 1 are denoted by the same reference symbols and will not be described repeatedly.

In the OPRM 2 of the fourth embodiment, a soundness checking basic signal transmitting section 18 is employed instead of the fixed simulated LPRM signal transmitting section of FIG. 1. The soundness checking basic signal transmitting section 18 transmits a signal for making the output of the input signal processing section 12 a signal operating as simulated cell value that is variable on a time series basis for checking the soundness of the trip determining section 13 and a fixed simulated LPRM signal to be input to the test OPRM cell.

The output of the soundness checking basic signal transmitting section 18 is input to the input signal processing section 12. The input signal processing section 12 outputs a simulated cell value for checking the soundness of the trip determining section 13 to the trip determining section 13 and also outputs a fixed simulated LPRM signal to the normalized cell value abnormality determining section 19 of the test OPRM cell.

Thus, in this embodiment, the position of the soundness checking basic signal transmitting section 18 of the trip determining section 13 is altered and arranged upstream relative to the input signal processing section 12 so that the soundness checking basic signal transmitting section 18 transmitting not only a signal for checking the soundness of the trip determining section 13 but also a fixed simulated LPRM signal for soundness checking. As a result, this embodiment can check the soundness of the trip determining section 13 and does not require any fixed simulated LPRM signal transmitting section 20 to make it possible to simplify the system configuration.

While certain embodiments have been described, these embodiments have been presented by way of example only, and are not intended to limit the scope of inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An oscillation power range monitor comprising:
an input signal processing section that calculates a normalized cell value from LPRM signals input from local power range monitors;
a soundness checking basic signal generating section that generates a simulated cell value that is variable on a time series basis; and
a trip determining section that receives the normalized cell value and the simulated cell value respectively from the input signal processing section and the soundness checking basic signal generating section as inputs, compares the normalized cell value and the simulated cell value with a determination threshold value and outputs a scram trip signal when either of them exceeds the determination threshold value.

2. The oscillation power range monitor according to claim 1, wherein
the soundness checking basic signal generating section transmits the simulated cell value in response to a change in a predetermined value of the trip determining section.

3. The oscillation power range monitor according to claim 1, wherein
the soundness checking basic signal generating section defines the simulated cell value by using a soundness checking sinusoidal wave.

4. An oscillation power range monitor comprising:
a soundness checking basic signal generating section that generates a signal for generating a simulated cell value that is variable on a time series basis;
an input signal processing section that calculates a normalized cell value and the simulated cell value respectively from LPRM signals input from local power range monitors and from a signal input from the soundness checking basic signal generating section; and
a trip determining section that receives the normalized cell value and the simulated cell value from the input signal processing section as inputs, compares the normalized cell value and the simulated cell value with a determination threshold value and outputs a scram trip signal when either of them exceeds the determination threshold value, wherein
the soundness checking basic signal generating section generates a fixed simulated LPRM signal and outputs the fixed simulated LPRM signal to the input signal processing section.

5. A method of checking the soundness of an oscillation power range monitor, the method comprising:
a step of calculating a normalized cell value from LPRM signals input from local power range monitors;
a step of generating a simulated cell value that is variable on a time series basis;
a step of comparing the normalized cell value and the simulated cell value with a determination threshold value; and
a step of outputting a scram trip signal when either of the normalized cell value and the simulated cell value exceeds the determination threshold value.
